(19) United States
(12) Patent Application Publication
(10) Pub. No.: US 2023/0183837 A1
(43) Pub. Date: Jun. 15, 2023

(54) Compositions and Methods for Improving Recovery of Lithium from Brines

(71) Applicant: LIXIVIA, INC., Santa Barbara, CA (US)

(72) Inventor: Michael D. Wyrsta, Santa Barbara, CA (US)

(21) Appl. No.: 17/925,751

(22) PCT Filed: Jun. 8, 2021
(86) PCT No.: PCT/US2021/036381

§ 371 Date: Nov. 16, 2022

Related U.S. Application Data
(60) Provisional application No. 63/037,995, filed on Jun. 11, 2020.

(51) Int. Cl. C22B 26/12

(52) U.S. Cl. CPC C22B 26/12

(57) ABSTRACT

Systems and methods are provided that remove calcium and/or magnesium from lithium-rich brines using industrial waste that includes calcium oxide or calcium hydroxide (such as steel slag). Surprisingly, calcium and magnesium can be selectively removed using such materials by controlling the ratio of lithium-rich brine to industrial waste. The contaminant-depleted brine so produced can be further purified and processed to generate lithium carbonate.

This application claims the benefit of U.S. Provisional Patent Application No. 63/037,995 filed on Jun. 11, 2020. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is recovery of lithium, particularly from brines.

### BACKGROUND

The background description includes information that may be useful in understanding the present invention. It is not an admission that any of the information provided herein is prior art or relevant to the presently claimed invention, or that any publication specifically or implicitly referenced is prior art.

The widespread use of lithium ion batteries has created a demand for lithium. Lithium is an abundant element, however, there are very few commercially viable resources where lithium is found in concentrations sufficient to produce useful lithium compounds in a commercially viable manner. The primary sources of lithium are in brines obtained from salars and salt lakes, and lithium-bearing spodumene ores. Geothermal brines represent the second most productive sources of lithium. Finally, wastewater from oil & gas fields are a potential untapped source of lithium that may grow in importance in the future.

Much of the world's commercial lithium is still recovered in the way it has been for the last half a century, by evaporating brines collected from salars and salt lakes in evaporation ponds. The process is lengthy and inefficient, and leaves behind a significant amount of salt waste.

Lithium recovery via conventional evaporation (and the resulting chemical precipitation) typically begins with subjecting a lithium-rich brine to a series of solar pond evaporations. South America contains vast amounts of salars that contain significant quantities of lithium. Other continents, including North America, contain naturally occurring brines with substantial lithium content. These brines, however, often contain large amounts of other salts, such as sodium chloride, potassium chloride, magnesium chloride and calcium chloride. Removing these other salts is expensive and time consuming.

In a typical evaporation process for recovering lithium large amounts of lithium-containing brine are pumped into evaporation ponds where over the course of about 18 months various salts are crystallized away from the lithium rich solution. Unfortunately, magnesium and calcium salts do not crystallize efficiently in this manner and often entrain large amounts of lithium when they crystallize.

Thus, there is still a need for rapid and efficient methods for recovering lithium from brines.

### SUMMARY OF THE INVENTION

The inventive subject matter provides apparatus, systems and methods in which contaminants are reduced in a lithium-containing brine.

Embodiments of the inventive concept provide compositions and methods for reducing contaminating metal content in a brine or salar by contacting a brine or salar that contains lithium and a first undesired metal with an amount of a divided solid comprising calcium oxide or calcium hydroxide (e.g., steel slag, ash, a calcium-containing mineral, organic material containing calcium oxide or calcium hydroxide, etc.) to generate a reaction mixture. This reaction mixture is incubated for a period of time that is sufficient to the concentration of the first undesired metal (e.g., magnesium) in the reaction mixture by at least 5% relative to the brine prior to treatment. The resulting modified brine is then separated from solids in the reaction mixture. The amount of the divided solid is selected such that the modified brine or salar retains at least 95% of lithium content of the brine (e.g., from about 3% w/v to about 20% w/v). In some embodiments the brine includes a second undesired metal (e.g., calcium), and the method also reduces concentration content of this second undesired metal. In such embodiments the divided solid can be applied at from about 1% w/v to about 9% w/v. In some embodiments concentration of both the first and second undesired metals are reduced. In such embodiments the divided solid can be added at from about 3% w/v to about 9% w/v. In any of these embodiments lithium can be separated from the modified or treated brine or salar.

Another embodiment of the inventive concept is a system for performing the method described above. Such a system includes a source of a lithium-containing solution (e.g., a lithium-rich brine or salar) and a source of a finely divided solid that includes calcium oxide and/or calcium hydroxide (as well as non-reactive, surface-exposed material). These sources are coupled to a reactor by suitable transport mechanisms, where they are contacted with each other. The reactor can incorporate devices that aid in performing and/or monitoring the reaction (e.g., a stirrer, a temperature control device, an ion-sensitive sensor, etc.). The slurry produced in the reactor includes a solution that retains lithium content but has a reduced content of contaminating metals (e.g., magnesium, calcium, etc.) relative to the lithium-containing solution. The system includes a separator for separating liquid and solid components of this slurry, which can be in the form of a distinct separator unit or can be embodied in the reactor. A separator can include a suitable separation mechanism, such as a decanter, centrifuge, filter, etc. In some embodiments solids recovered from this separation process are transferred back to the source of finely divided solid and recycled through the process.

In some embodiment additional system components are provided for further processing of the liquid portion of the slurry produced in the reactor. From the separator, the contaminant-depleted liquid can be transferred to a second reactor, which is in turn in communication with a source of carbonate (e.g., sodium carbonate) and a mechanism for transferring the carbonate to the second reactor. This second reactor can incorporate devices that aid in performing and/or monitoring a lithium carbonation reaction within the second reactor (e.g., a stirrer, a temperature control device, an ion-sensitive sensor, etc.). The lithium carbonation reaction generates a slurry that includes a solid lithium carbonate component with a further reduced content of contaminating metals. This solid component is separated from the residual liquid in a second separator, which can be a distinct separator unit or embodied in the second reactor. Such a s second separator can include a suitable separation mechanism, such as a decanter, centrifuge, filter, etc.

In some embodiments of the inventive concept, such a system can include a controller that is communicatively coupled to active system components (e.g., stirrers, temperature control devices, transport mechanisms, pumps, actuated flow control devices, etc.) and/or sensors of the system. Such a control can permit partial or total automation of processes performed using such a system.

Various objects, features, aspects and advantages of the inventive subject matter will become more apparent from the following detailed description of preferred embodiments.

### BRIEF DESCRIPTION OF THE DRAWINGS

FIG. 1 schematically depicts an exemplary process of the inventive concept.

FIG. 2 schematically depicts an exemplary system of the inventive concept.

FIG. 3 provides a graph showing typical results from addition of steel slag to a lithium-containing brine. The Y axis represents the amount of Li, Mg, and Ca remaining in solution in ppm, and the X axis represents the amount of steel slag added in mg per 10 grams of brine.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventive subject matter provides compositions and methods in which a magnesium and/or calcium is substantially removed from lithium-containing brines and/or salars without significant loss of lithium from the solution. This removal of magnesium and/or calcium advantageously simplifies subsequent recovery of lithium from solution. Removal of these interfering salts can also reduce processing time required for recovery of lithium from brines and/or salars relative to conventional methods. In addition, lack of entrainment of lithium in precipitated magnesium and/or calcium salts can improve yield of lithium from such brines and/or salars relative to conventional methods.

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Inventors have, surprisingly, found that addition of slag produced during steel manufacturing to lithium-containing brines contaminated with magnesium and calcium has the effect of precipitating contaminating magnesium and/or calcium from these solutions. It should be appreciated that steel slag is an abundant and inexpensive waste product, that is often simply discarded. The Inventors contemplate that other inorganic and organic solids that include calcium oxide/hydroxide and provide a reactive surface area can also be used.

In a typical method of the inventive concept a quantity of a calcium oxide and/or calcium hydroxide containing divided solid (e.g., steel slag, ash, calcium-containing minerals, etc.) is mixed with a lithium-containing solution (e.g., a brine or a salar) that also contains unwanted mineral contaminants (e.g., magnesium and/or calcium). The amount of calcium oxide and/or calcium hydroxide (such as steel slag) added can range from about 0.1% w/v to about 50% w/v, and can be adjusted based on the content of the divided solid being added and/or content of the lithium containing brine and/or salar. For example, a lithium-containing brine and/or salar having a relatively low calcium content can be treated with a relatively large amount of steel slag (e.g., from about 5% w/v to about 30% w/v) in order to precipitate magnesium from the solution.

Alternatively, a lithium-containing brine having a relatively low magnesium content but significant calcium content can be treated with a relatively small amount of steel slag (e.g., from about 1% w/v to about 9% w/v). Brines so treated typically show no significant loss of lithium content (e.g., less than 5%). Steel slag can be re-sized prior to application to the brine, for example by sifting, grinding, etc. in order to provide greater surface area for reaction.

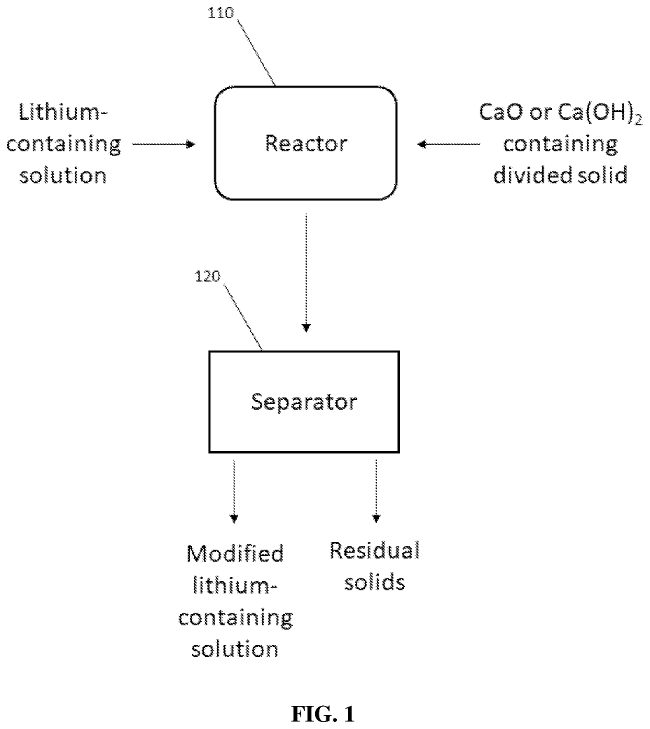

An exemplary process of the inventive concept is shown in FIG. 1. As shown, a lithium-containing solution (typically a brine or salar having a high content of lithium salts) with unwanted metal contaminants (e.g., magnesium and/or calcium) is introduced to a reactor (110), where it is contacted with a divided (e.g., particulate) solid that contains calcium oxide and/or calcium hydroxide. The divided solid can be present in the reactor at the time of introduction of the brine and/or salar, added essentially simultaneously with the brine and/or salar, or added to the reactor after introduction of the brine and/or salar. The reactor (110) can be in the form of an enclosed vessel, an open vessel or vat, or a pond or similar reservoir. In some embodiments the reactor (110) can include a mixing device (e.g., a rotor, a paddle, a pump, etc.) that provides mixing between the lithium-containing brine or salar and the divided solid.

The ratio of divided solid to lithium-containing brine or salar can be adjusted in order to account for the composition of the divided solid and/or the lithium-containing brine and/or salar. In addition, the ratio of divided solid to lithium-containing brine or salar can be adjusted to accomplish an effect in regard to contaminant removal. For example, as shown below, adjusting the ratio of a steel slag to a lithium-containing brine with magnesium and calcium contaminants can provide selective removal of calcium, selective removal of magnesium, or removal of both calcium and magnesium from the lithium-containing brine. Accordingly, the desired or optimal ratio of divided solid to lithium-containing solution can be determined preparing test samples of the divided solid mixed with the lithium-containing solution at various ratios and characterizing lithium and unwanted contaminating metal content of the resulting treated solution. The desired ratio can then be applied to a full-scale reaction. Time course for the extraction of unwanted metals can be similarly determined, and can range from 5 minutes to one week or more, or any suitable interval within this range).

Mixing the divided solids with the lithium-containing solution within the reactor generates a slurry. Reactions within the reactor transfer unwanted metals (e.g., magnesium, calcium, etc.) from solution to the solid phase of the slurry (for example, by precipitation of the unwanted metals as insoluble salts). The resulting solution portion of the slurry has a reduced contaminant content and is more suitable for isolation of high-purity lithium. Accordingly, following reaction in the reactor (110) for a suitable period of time the resulting slurry is transferred to a separator (120). Separation between liquid and particulate phases of the slurry can be accomplished by any suitable mechanism, including settling, decantation, centrifugation, filtration, etc. In some embodiments the separation mechanism can be incorporated into the reactor (110), allowing it to act as both a reactor and a separator.

Following separation, the liquid phase, having a reduced level of unwanted metal contamination, can be transferred to a traditional lithium recovery process to generate high-purity lithium. Typically, only a small amount of lithium content (e.g., less than 15%, less than 10%, less than 5%, less than 2.5%, or less than 1%) of lithium content is lost during removal of unwanted metals by methods of the inventive process. Additional processes can be applied to the separated liquid phase to further reduce remaining content of unwanted metals, such as precipitation using precipitants that leave lithium in solution (e.g., by generating relatively soluble lithium salts).

Solids recovered from the slurry can be processed for recovery of the metals removed from the lithium-containing solution. Alternatively, solids recovered from the slurry can be recycled for re-use as a divided solid in processing of a new lot of lithium-containing brine. It should be appreciated that the ratio of divided solid to lithium-containing brine may need to be re-optimized for such recycled material.

In a typical method of the inventive concept steel slag, ash, or similar calcium oxide and/or calcium hydroxide containing industrial waste that would otherwise be discarded can act as a divided solid. Such a typical method can utilize lithium-containing brines that include concentrations of magnesium and calcium that render them unusable in current processes for producing high purity lithium, which are relatively abundant.

Following treatment with steel slag to reduce magnesium and/or calcium content, the treated brine can be separated from residual solids (e.g., treated steel slag, precipitated magnesium, precipitated calcium, etc.), and lithium subsequently recovered from the magnesium and/or calcium depleted solution. Separation can be performed by any suitable method. Suitable methods include, but are not limited to, settling, decantation, filtration, and centrifugation.

Any suitable process can be applied to the magnesium and/or calcium depleted brine so generated in order to recover its lithium content, for example by adding a source of carbonate (e.g., a carbonate salt). The treated solution that results can then then subjected to a carbonation process, where the lithium reacts with the carbonate at about 50° C., 60° C., 70° C., 80° C., 90° C., or 100° C. to produce technical-grade lithium carbonate. This can be further purified to produce battery-grade lithium by re-dissolving the lithium carbonate, and then using an ion exchange process to remove impurities.

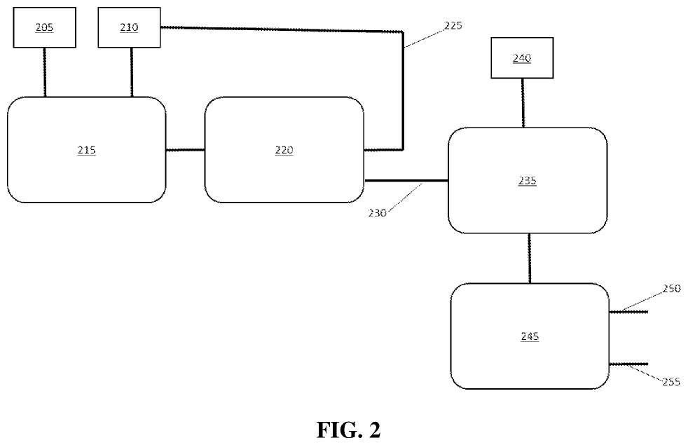

Another embodiment of the inventive concept is a system for purifying lithium from lithium-containing solutions (such as lithium-containing brines and/or salars) using methods as described above. An example of such a system is shown in FIG. 2. As shown, a source of a lithium-containing solution (205) and a source of a divided solid that contains calcium oxide and/or calcium hydroxide (210) are fluidically connected to a reactor (215). The source of lithium-containing solution (205) can be a vessel, reservoir, tank, pond, pressurized line, or similar structure supportive of fluid content, and can contain or support a flow of lithium-containing brine or salar. The source of the divided solid that includes calcium oxide and/or calcium hydroxide can be a tank, hopper, conveyer, or other suitable solids transfer device, and can include steel slag, ash, calcium-containing industrial waste, and/or calcium-containing minerals.

Connections between the reactor (215) and the source of lithium-containing solution (205) can include a flow control device, such as a pump and/or valve (not shown), that permits regulation of the flow of fluid into the reactor (215). Such flow can be periodic (e.g., for stepwise processes) or continuous (e.g., for continuous processes). Such a flow control device can be a manual device or an actuated device. If actuated, such a flow control device can be communicatively coupled to or otherwise controlled by a controller (not shown).

Similarly, connections between the reactor (215) and the source of divided solid containing calcium oxide and/or calcium hydroxide (210) can include a flow control device (not shown) such as a valve, gate, or speed regulator (for conveyer devices) that permits regulation of the flow of divided solid containing calcium oxide or calcium hydroxide into the reactor (215). Such flow can be periodic (e.g., for stepwise processes) or continuous (e.g., for continuous processes). Such a flow control device can be a manual device or an actuated device. If actuated, such a flow control device can be communicatively coupled to or otherwise controlled by a controller (not shown).

A reactor (215) of such a system can include one or more accessory devices (not shown) that aid in the performance of the contaminant removal process. Such accessory devices include a mixing or agitation device to aid in mixing and the suspension of solids, a temperature control device (e.g., a heat exchanger, a heat pipe, a heater, a piezoelectric cooler, etc.) to generate or maintain a desired temperature or temperature range, and/or one or more sensors (e.g., an ion-selective electrode) to monitor the progress of the reaction. Such accessory devices can be controlled by and/or provide data to a controller.

Following depletion of contaminants from the lithium-containing slurry generated in the reactor (215), further steps require separation of the contaminant-depleted liquid phase from the residual finely divided solid component of the slurry. Separation can be accomplished by any suitable method, such as settling, decantation, centrifugation, filtration, etc. In some embodiments of the inventive concept this separation is accomplished by transferring contents of the reactor (215) to a separator (220), wherein such separation takes place to generate a stream of solids (225) that includes the residual finely divided solid and a stream of liquid (230) that includes the contaminant-depleted, lithium-containing liquid phase. In some embodiments all or a portion of the stream of residual finely divided solid (225) can be recycled back into the process as a finely divided solid that includes calcium oxide and/or calcium hydroxide.

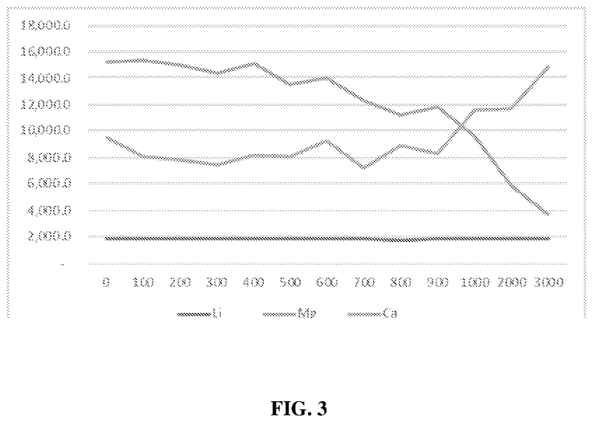

In the exemplary system shown in FIG. 3, the separator (220) is provided as a distinct unit. Alternatively, in some embodiments the reactor (215) can also serve as a separator. For example, separation can be accomplished in the reactor (215) by halting a mixing device and allowing solids to settle. The remaining liquid fraction can then be removed by decanting or pumping. In such embodiments the reactor (215) also embodies the separator (220).

In some embodiments of the inventive concept the contaminant-depleted stream of liquid (230) can be further processed. In the exemplary system shown in FIG. 2 this stream is directed to a secondary reactor (235), which is also in communication with a source of carbonate (240). Suitable sources of carbonate can be a tank, hopper, conveyer, or other suitable solids transfer device that contain or transport a carbonate salt (such as sodium carbonate), which can be provided in a flowable form (e.g., powder, granule, pellet, solution, etc.).

Connections between the secondary reactor (235) and the source of carbonate (240) can include a flow control device (not shown) such as a valve, gate, or speed regulator (for conveyer devices) that permits regulation of the flow of carbonate into secondary the reactor (235). Such flow can be periodic (e.g., for stepwise processes) or continuous (e.g., for continuous processes). Such a flow control device can be a manual device or an actuated device. If actuated, such a flow control device can be communicatively coupled to or otherwise controlled by a controller (not shown).

A secondary reactor (235) of such a system can include one or more accessory devices (not shown) that aid in the performance of the contaminant removal process. Such accessory devices include a mixing or agitation device to aid in mixing and the suspension of solids, a temperature control device (e.g., a heat exchanger, a heat pipe, a heater, a piezoelectric cooler, etc.) to generate or maintain a desired temperature or temperature range, and/or one or more sensors (e.g., an ion-selective electrode) to monitor the progress of the reaction. Such accessory devices can be controlled by and/or provide data to a controller.

Reactions within the secondary reactor (235) can generate a slurry that includes a lithium carbonate solid, which can be separated from the metal contaminant-containing liquid phase. Separation can be accomplished by any suitable method, such as settling, decantation, centrifugation, filtration, etc. In some embodiments of the inventive concept this separation is accomplished by transferring contents of the secondary reactor (235) to a secondary separator (245), wherein such separation takes place to generate a stream of solids (255) that includes lithium carbonate and a stream of liquid (250) that includes metal contaminants. In some embodiments the stream of liquid (250) can be further process to recover additional metals that would be considered contaminants in lithium-isolating processes.

In the exemplary system shown in FIG. 3, the secondary separator (245) is provided as a distinct unit. Alternatively, in some embodiments the secondary reactor (235) can also serve as a separator. For example, separation can be accomplished in the secondary reactor (235) by halting a mixing device and allowing solids to settle. The liquid fraction can then be removed by decanting or pumping. In such embodiments the reactor (235) also embodies the separator (245).

### EXAMPLES

10 grams of brine from Chile, containing approximately 1800 ppm Li, was mixed with various amounts of ground steel slag at ambient temperature and pressure. Such steel slag provides a source of calcium oxide/hydroxide as well as non-reactive surface. The suspension was stirred for 45 minutes. Solids were then removed by filtration. The remaining clear solution was characterized via ICP-MS. Results are shown in Table 1. Results from Table 1 are shown graphically in FIG. 3, where the Y axis represents the amount of Li, Mg, and Ca remaining in solution in ppm, and the X axis represents the amount of steel slag added in mg. Table 2 shows the percentage change in magnesium and calcium content in the treated brine relative to untreated brine using different amounts of added steel slag.

TABLE 1

| Steel Slag addition | | | |
|---|---|---|---|
| (mg per 10 g brine) | Li (ppm) | Mg (ppm) | Ca (ppm) |
| 0 | 1,817.6 | 15,147.3 | 9,473.3 |
| 100 | 1,810.0 | 15352.5 | 8,022.1 |
| 200 | 1,809.5 | 14,975.7 | 7,802.6 |
| 300 | 1,886.8 | 14,407.9 | 7,433.1 |
| 400 | 1,850.1 | 15,084.9 | 8,141.4 |
| 500 | 1,831.1 | 13,461.2 | 8,052.9 |
| 600 | 1,862.3 | 14,025.8 | 9,300.1 |
| 700 | 1,866.9 | 12,234.6 | 7,159.8 |
| 800 | 1,788.3 | 11,195.4 | 8,842.0 |
| 900 | 1,826.8 | 11,741.1 | 8,310.8 |
| 1,000 | 1,802.2 | 9,654.2 | 11,513.6 |
| 2,000 | 1,843.9 | 5,856.9 | 11,652.1 |
| 3,000 | 1,879.3 | 3,621.2 | 14,804.9 |

TABLE 2

| Steel Slag addition | | |
|---|---|---|
| (mgs per 10 g brine) | Change in Mg, % | Change in Ca, % |
| 0 | N/A | N/A |
| 100 | 1.35% | −15.32% |
| 200 | −1.13% | −17.64% |
| 300 | −4.88% | −21.54% |
| 400 | −0.41% | −14.06% |
| 500 | −11.13% | −14.99% |
| 600 | −7.40% | −1.83% |
| 700 | −19.23% | −24.42% |
| 800 | −26.09% | −6.66% |
| 900 | −22.49% | −12.27% |
| 1000 | −36.26% | 21.54% |
| 2000 | −61.33% | 23.00% |
| 3000 | −76.09% | 56.28% |

Surprisingly, Inventors discovered a decrease in the calcium content of the brine as well as a decrease in magnesium content. This is particularly surprising in view of the considerable calcium content of the steel slag. Without wishing to be bound by theory, the Inventors believe that this is due to the general characteristics of the combination of reactive calcium minerals present in the steel slag and non-reactive components in the slag. These can act as a surface to adsorb magnesium and calcium precipitates. Another surprising result is the observation that no lithium was lost in the precipitation of calcium and magnesium.

While results with steel slag are provided above, Inventors believe that similar results can be obtained with the use of a variety of inorganic solids that contain reactive and nonreactive components. Examples of such inorganic solids include, ash, cement kiln dust, lime waste, mixtures of lime and other solids such as sand, wood products, and other solids that contain calcium oxide/hydroxide and also non-reactive surfaces.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1-23. (canceled)

24. A method of reducing metal content in a brine, comprising;
contacting a brine comprising lithium and a first undesired metal with an amount of a divided solid comprising calcium oxide or calcium hydroxide to generate a reaction mixture;
incubating the reaction mixture for a period of time sufficient to reduce solution concentration of the first undesired metal in the reaction mixture by at least 5% relative to the brine; and
separating a modified brine from solids in the reaction mixture,
wherein the amount of the divided solid is selected such that the modified brine retains at least 95% of lithium content of the brine.

25. The method of claim 24, wherein the undesired metal is magnesium.

26. The method of claim 24, wherein the divided solid comprises a selected from the group consisting of a steel slag, an ash, a calcium-containing mineral, and an organic material comprising calcium oxide or calcium hydroxide.

27. The method of claim 24, comprising applying the divided solid at from 3% w/v to 20% w/v.

28. The method of claim 24, wherein the brine comprises a second undesired metal, and comprising reducing concentration content of the second undesired metal.

29. The method of claim 28, wherein the second undesired metal is calcium.

30. The method of claim 28, comprising applying the divided solid at from 1% w/v to 9% w/v.

31. The method of claim 28, comprising reducing concentration of both the first and second undesired metals.

32. The method of claim 31, comprising applying the divided solid at from 3% w/v to 9% w/v.

33. The method of of claim 24, comprising separating lithium from the modified brine.

34. The method of claim 33, comprising adding a source of carbonate to the modified brine to generate lithium carbonate.

35. A system for reducing metal contamination in a lithium-containing solution, comprising:
a source of the lithium-containing solution [205];
a source of a divided solid [210], wherein the divided solid comprises calcium oxide or calcium hydroxide;
a primary reactor [215] fluidically coupled to the source of the lithium-containing solution [205] and the source of the divided solid [210]; and
a primary separator [220] configured to separate a first slurry obtained from the primary reactor [215] into a first solid and a first solution, wherein the primary separator comprising a first output [225] configured to transfer the first solid from the primary separator [220] and a second output [230] configured to transfer the first solution from the primary separator [220].

36. The system of claim 35, wherein the primary separator [220] is embodied in the primary reactor [215].

37. The system of claim 35, wherein the first output [225] is fluidically coupled to the source of the divided solid [210].

38. The system of claim 35, comprising:
a secondary reactor [235] fluidically coupled to the second output [230]; and
a source of carbonate [240] fluidically coupled to the secondary reactor [235]; and
a secondary separator [245] configured to separate a second slurry from the secondary reactor [235] into a second solid and a second solution, comprising a third output configured to discharge the second solid from the secondary separator [245] and a fourth output [255] configured to discharge the second solution from the secondary separator [245].

39. The system of claim 38, wherein the source of carbonate [240] comprises sodium carbonate.

40. The system of claim 38, wherein the secondary separator [245] is embodied in the secondary reactor [235].

41. The system of claim 38, wherein the secondary reactor [245] comprises a heater.

42. The system of claim 35, wherein the source of the lithium-containing solution [205] comprises a lithium-containing brine or salar.

43. The system of claim 35, wherein the source of the divided solid [210] comprises one the group consisting of steel slag, ash, and a calcium-containing mineral.
